(19) United States
(12) Patent Application Publication
(10) Pub. No.: US 2003/0135605 A1
(43) Pub. Date: Jul. 17, 2003

(54) User rating feedback loop to modify virtual channel content and/or schedules

(76) Inventor: Ramesh Pendakur, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/044,546

(22) Filed: Jan. 11, 2002

(51) Int. Cl. H04N 7/173; G06F 15/173

(52) U.S. Cl. 709/224; 725/109

(57) ABSTRACT

A method and apparatus are provided for caching and rating virtual channels and modifying future content and/or content schedules based on user preferences. According to one embodiment of the present invention, a mechanism for providing categorized virtual channel presentations using cached content, along with content discovery information is provided. These channels enable the user to select the “type” or “genre” of content for consumption and to actively or passively rate this content. The rating information may then be used to modify the future content and/or content scheduling for the network.

### FIELD OF THE INVENTION

The invention relates generally to the field of digital broadcasts. More particularly, the invention relates to caching and rating virtual channels for modifying future content schedules.

### BACKGROUND OF THE INVENTION

0There are various well-known systems for broadcasting digital information such as digital television content. For example, cable and satellite television broadcast systems presently utilize digital broadcasts to transmit television content to their subscribers. Additionally, over-the-air digital broadcasts of television content are now becoming more common and will continue to replace analog broadcasts.

These digital broadcasts generally provide very large bandwidth. Over-the-air American Television Standards Committee (ATSC) standard digital broadcasts are capable of 19.2 Mbits per second. Cable broadcasts are capable of 30-38 Mbits per channel. Satellite broadcasts operate at speeds of 30 Mbits/transponder. However, it is not enough to send high bandwidth data to a consumer. The problem is, if the content is not tailored to the tastes of the consumers, it is possible to fill even high bandwidth with unpopular and unused information. Therefore, a content provider may want to tailor a broadcast to get the right data to the right user at the right time. By providing only content that is in demand, a content provider can avoid wasting bandwidth on content that is not consumed and thereby increase revenues in terms of dollar per bit of bandwidth.

Rating services available today, such as the Neilson service, provide some feedback to content providers regarding the popularity of their content. However, such services do not provide very detailed information and cannot provide feedback to the content provider in anything approaching real-time. Therefore, the content providers can make judgments based only on rough data that is not available in a very timely fashion.

### BRIEF DESCRIPTION OF THE DRAWINGS

The appended claims set forth the features of the invention with particularity. The invention, together with its advantages, may be best understood from the following detailed description taken in conjunction with the accompanying drawings of which:

FIG. 1A is a diagram illustrating an example of a typical local broadcast system upon which embodiments of the present invention may be implemented;

FIG. 1B is a diagram illustrating an example of a typical satellite broadcast system upon which embodiments of the present invention may be implemented;

FIG. 1C is a diagram illustrating an example of a national broadcast system upon which embodiments of the present invention may be implemented;

FIG. 1D is a diagram illustrating an example of a typical cable broadcast system upon which embodiments of the present invention may be implemented;

FIG. 2 is a block diagram illustrating a high-level, conceptual view of a system for distributing, consuming, and modifying content based on user preferences according to one embodiment of the present invention;

FIG. 3 is a flowchart illustrating a high-level view of modifying content based on user preferences according to one embodiment of the present invention;

FIG. 4 is a block diagram illustrating a content provider system to generate and modify content based on user preferences according to one embodiment of the present invention;

FIG. 5 is a block diagram illustrating an head-end system for distributing content according to one embodiment of the present invention;

FIG. 6 is a block diagram illustrating a receiver according to one embodiment of the present invention;

FIG. 7 is a flowchart illustrating a process for generating content to be broadcast according to one embodiment of the present invention;

FIG. 8 is a flowchart illustrating a process for broadcasting content according to one embodiment of the present invention;

FIG. 9 is a flowchart illustrating a process for,receiving and caching content according to one embodiment of the present invention;

FIG. 10 is a flowchart illustrating a process for accumulating user preferences according to one embodiment of the present invention; and

### DETAILED DESCRIPTION OF THE INVENTION

A method and apparatus are described for caching and rating virtual channels and modifying future content schedules based on user preferences. According to one embodiment of the present invention, a mechanism for providing categorized virtual channel presentations using cached content, along with content discovery information is provided. These channels enable the user to select the “type” or “genre” of content for consumption and to actively or passively rate this content. The rating information is used to modify the future content scheduling for the network.

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various methods, which will be described below. The methods of the present invention may be performed by hardware components or may be embodied in machine-executable instructions, which may be used to cause a general-purpose or special-purpose processor or logic circuits programmed with the instructions to perform the methods. Alternatively, the methods may be performed by a combination of hardware and software.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Importantly, while embodiments of the present invention will be described with reference to the broadcast of television type content, the method and apparatus described herein are equally applicable to other types of content that can be represented in digital form. For example, the techniques described herein are thought to be useful in connection with the broadcast of music, multimedia presentations, text, video, and other forms of digital data.

As mentioned above, there are various well-known systems for broadcasting digital information such as television content. For example, cable and satellite television broadcast systems presently utilize digital broadcasts to transmit television content to their subscribers. Additionally, over-the-air digital broadcasts of television content are now becoming more common and will continue to replace analog broadcasts. Various embodiments of the present invention, as will be described in detail below, are equally applicable to any of these broadcast systems.

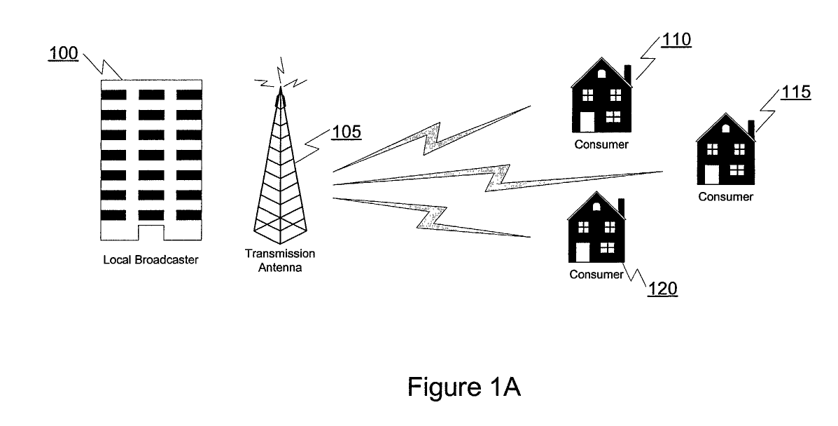

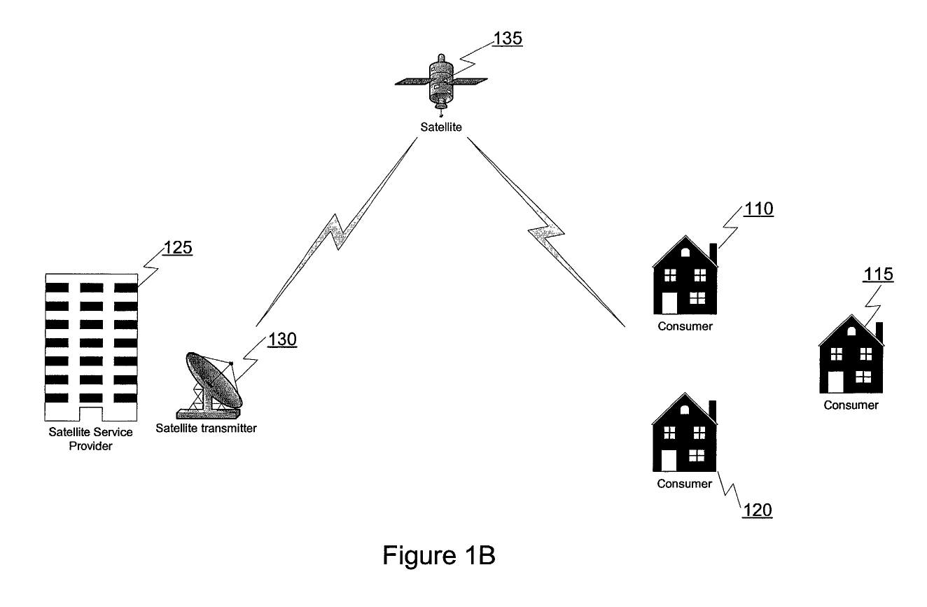

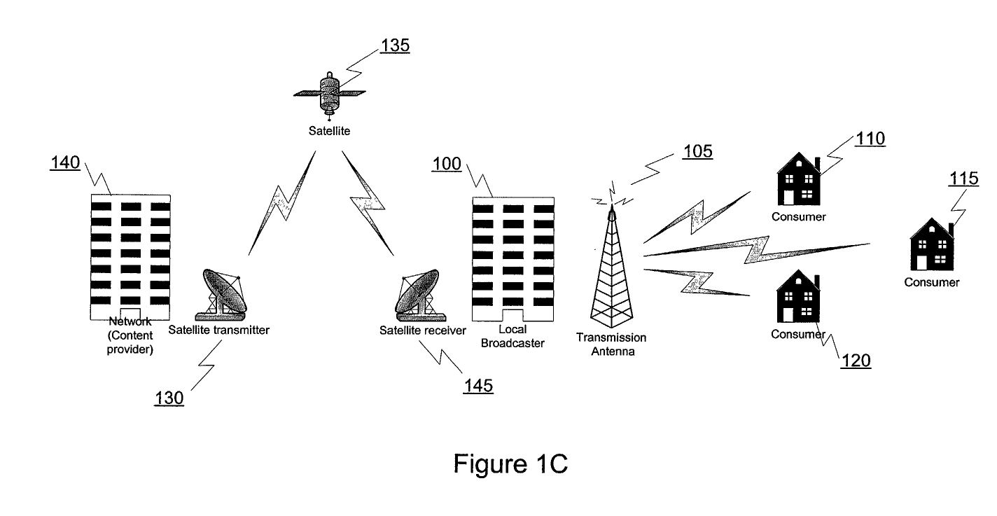

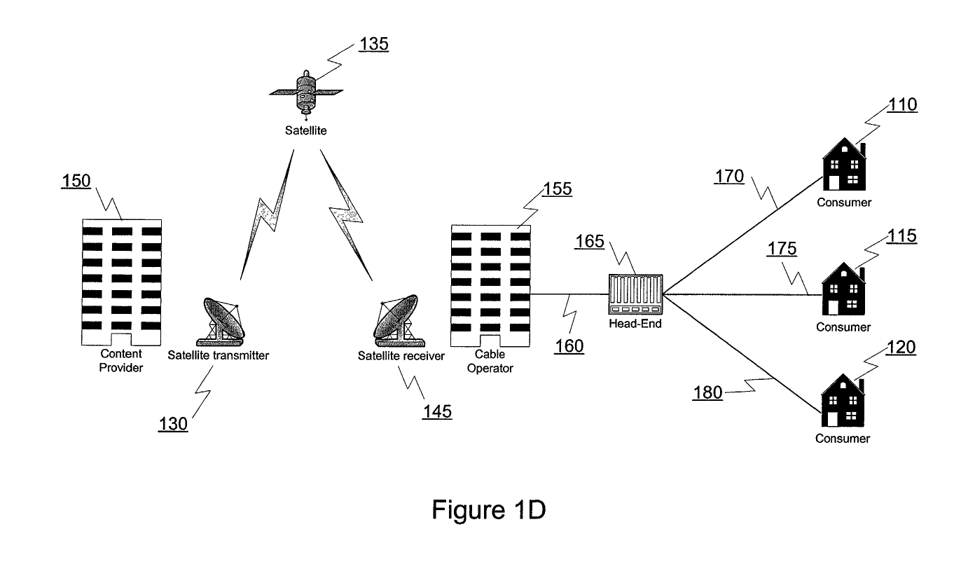

FIG. 1A is a diagram illustrating an example of a typical local broadcast system upon which embodiments of the present invention may be implemented. Here, a local broadcaster 100 is providing content to a group of consumers 110, 115, and 120. The local broadcaster 100, after generating content to be broadcast, modulates a carrier frequency with the content for transmission from a transmission antenna 105 to the consumers 110, 115, and 120. The consumers 110, 115, and 120 then receive, demodulate, and consume the content normally in real-time as the broadcast is occurring.

FIG. 1B is a diagram illustrating an example of a typical satellite broadcast system upon which embodiments of the present invention may be implemented. Here, similar to the local broadcaster described above, the satellite service provider 125 generates content and uses it to modulate a carrier frequency for transmission from a satellite transmitter 130 to a satellite 135. The satellite 135 then retransmits the signal to a group of consumers 110, 115, 120 with the proper equipment for receiving and decoding the transmission. The consumers 110, 115, and 120 then receive, demodulate, and consume the content normally in real-time as the broadcast is occurring.

FIG. 1C is a diagram illustrating an example of a national broadcast system upon which embodiments of the present invention may be implemented. This basic example illustrates a system that may be used by one of the national networks. Here, the network 140 is the content provider. The network 140 generates content and uses it to modulate a carrier frequency for transmission from a satellite transmitter 130 to a satellite 135. The satellite 135 then retransmits the signal to a satellite receiver 145 at the local broadcaster 100. The local broadcaster then retransmits the content from a transmission antenna to a group of consumers 10, 115, and 120 who then receive, demodulate, and consume the content. Alternatively, the link between the network 140 and the local broadcaster 100 via the satellite transmitter 130, the satellite 135, and the satellite receiver 145 may be replaced by a direct, dedicated connection or a network connection such as an Asynchronous Transfer Mode (ATM) backbone or the Internet.

FIG. 1D is a diagram illustrating an example of a typical cable broadcast system upon which embodiments of the present invention may be implemented. Here, a content provider 150, such as those that commonly supply news, sports, premium channels, etc. generates content and uses it to modulate a carrier frequency for transmission from a satellite transmitter 130 to a satellite 135. The satellite 135 then retransmits the signal to a satellite receiver 145 at the cable operator 155. Alternatively, the link between the content provider 150 and the cable operator 155 via the satellite transmitter 130, the satellite 135, and the satellite receiver 145 may be replaced by a direct, dedicated connection or a network connection such as an ATM backbone or the Internet.

The cable operator 155, after receiving content from the content provider 150, then usually combines that content with other content from various other content providers such as premium service providers, national networks, local stations and others. The cable operator 155 then sends the content to one or more head-ends 165 via a fiber optic network 160. The head-end 165 then distributes the content, normally via copper wire 170, 175, and 180, to one or more consumers 110, 115, and 120.

As mentioned above, all of the types of broadcasts described can be broadcasts of digital data. In each case, a Radio Frequency (RF) carrier signal is modulated with a digital representation of the content. For example an Motion Pictures Group (MPEG) 2 encoding of a television broadcast can be used to modulate a carrier signal. The modulated carrier is then transmitted over air or wire.

These digital broadcasts generally provide very large bandwidth. Over-the-air ATSC standard digital broadcasts are capable of 19.2 Mbits per second. Cable broadcasts are capable of 30-38 Mbits/channel. Satellite broadcasts operate at speeds of 30 Mbits/transponder. This high bandwidth can allow for a transport data stream to be made up of a bit stream multiplex that carries different information on one multiplex. For example, a digital broadcast can carry an MPEG2 multiplex containing multiple audio, multiple video and multiple data streams instead of one video and one audio track as is typical with an analog broadcast. This ability to multiplex bitstreams into a transport stream allows for virtual channels within one physical channel. For example, a Public Broadcasting System (PBS) virtual channel may comprise PBS Kids, PBS News, PBS History, etc.

However, it is not enough to send high bandwidth data to a consumer. The problem is, if the content is not tailored to the tastes of the consumers, it is possible to fill even high bandwidth with unused information. Therefore, a content provider may want to tailor a broadcast to get the right data to the right user at the right time. By providing only content that is in demand, a content provider can avoid wasting bandwidth on content that is not consumed and thereby increase revenues in terms of dollar per bit of bandwidth.

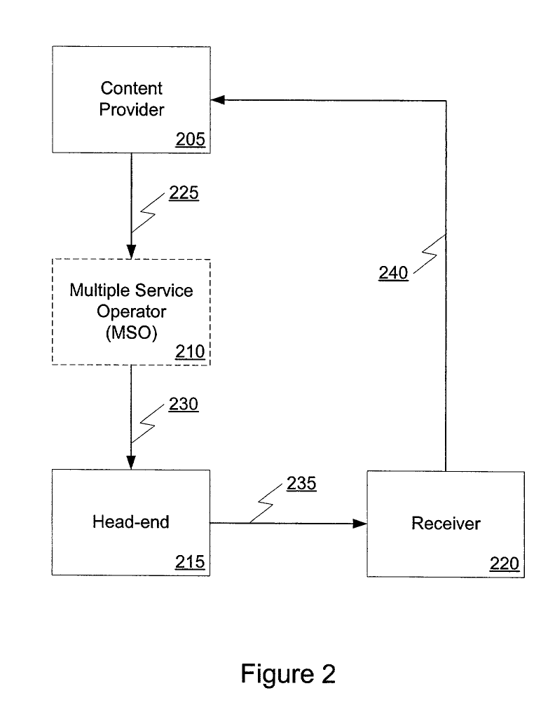

FIG. 2 is a block diagram illustrating a high-level, conceptual view of a system for distributing, consuming, and modifying content based on user preferences according to one embodiment of the present invention. In this example, the system consists of a content provider 205, a broadcasting head-end system 215, and a receiver device 220. This system also includes a feedback channel 240 to feed content rating information generated at the receiver 220 back to the content provider 205 for use in modifying and driving future content schedules. The system may also include a Multiple Service Operator (MSO) 210 such as a cable broadcast system as described above with reference to FIG. 1D. This MSO 210 provides an interface between the content provider 205 and the head-end 215. However, the MSO 210 is optional in that the content provider 205 may in fact be an MSO 210 thereby eliminating the distinction.

As described above, the content provider 205 generates content to be distributed to one or more consumers. According to one embodiment of the present invention, instead of content being a linear set of content pieces as is common with analog broadcasts, the content is composed of a number of virtual channels or groupings of content. Included in this content are multiple descriptors for the virtual channel as well as the individual content. These descriptors can be simple or detailed. For example, the descriptors can be text paragraphs for content pieces. As will be described below, a receiver can later analyze the descriptors and categorize the content accordingly.

According to one embodiment of the present invention, content discovery information, such as content descriptors and announcements, may be provided in real-time or preshow as an in-band communication. Content descriptors may comprise attribute/value pairs of metadata. For example, if the content to be distributed is a movie, for the given movie the content provider 205 can come up with metadata that is detailed enough to determine whether a given consumer will like the movie based on a user profile, past preferences, etc. This set of metadata may include descriptors such as actors, theme, type of content, studio, year, type of music, etc. As will be described below, the receiver can compare this data with a locally stored user profile and determine a degree of correlation. If the correlation is high correlation, the receiver can cache the content for later consumption.

The content data can then be sent 225 from the content provider 205 either to an MSO 210 or directly to a head end 215. This transmission can be accomplished in at least two ways. One way is to send the data encapsulated in Internet Protocol (IP) packets over the Internet or an ATM backbone network to a router connected to an MSO or head-end. Another method is similar to that described above with reference to FIG. 1D. That is, like traditional cable systems the content provider 205 sends the data to a satellite to be beamed to multiple locations. An MSO or head-end will then receive the content provider's multiplex as a digital bitstream and re-multiplex this bitstream into another multiplex such as an MPEG2 multiplex to be sent to a head-end or consumers. The method used depends on the exact application. If there are many points that the content provider will distribute to, satellite is better. If there are only a few points, an ATM backbone is better in terms of cost. In either case, the underlying technology is IP multicast. The content provider creates IP multicast bitstreams to be placed into another multiplex such as an MPEG2 transport.

The MSO 210, if used, receives 225 content from the content provider 205 and sends 230 it to a head-end 215. An MSO 210 can receive input 225 from multiple content providers 205, multiplex the content into a data stream and send the combined content to multiple head-ends 215. The head-end 215 typically receives an input 230 on fiber optic cables from an MSO 210 or content provider 205 and provides an output 235 on copper wires for distributing content to one or more consumers.

The receiver 220 is located with the consumer, typically in his home. This device 220 could be a personal computer (PC), set top box, personal video recorder (PVR), residential gateway, media server in home, a television with a built in decoder, etc. In other words, it is a content consuming device of some type. The receiver 220 accepts input 235 from the head-end 215, decodes it and then caches or presents it to the consumer for immediate consumption.

As described above, a digital broadcast need not be like an analog broadcast in that it never needs to be consumed in real-time. These broadcast can always be cached and time shifted. According to one embodiment of the present invention, the receiver 220 acts as a filtering and caching device to selectively store content for later consumption. Consequently, only that data which is of interest to the consumer may be cached. As will be described below, the receiver can compare metadata within the content with a locally stored user profile and determine a degree of correlation. If the correlation is high, the receiver can cache the content for later consumption.

Additionally, only that content that will be cached by consumers and presumably later consumed needs to be broadcast. Otherwise, broadcasting content that is not cached wastes bandwidth. Therefore, the receiver 220 provides, according to one embodiment of the present invention, a mechanism for rating the content received. This can be accomplished by both active and passive means. Active feedback can be obtained through the receiver by querying the consumer regarding his preferences. Passive feedback can be obtained by monitoring the consumer's habits with regard to the types and amounts of content consumed. This feedback is then used to develop a user profile and preference data.

The feedback channel 240 provides a means for the content provider 205 to obtain feedback from the consumers regarding the types of content consumed. This mechanism provides a feedback loop for the service provider to dynamically introduce or edit a channel line-up for any given timeslot. For example, if the service provider detects that country music is not popular with the audience, he can simply add other channels to replace it within the timeslot. Or, if it is detected that country music is popular, he can increase the amount of this type of music that is transmitted as compared to others.

According to one embodiment of the present invention, the feedback channel 240 is a persistent back-channel between the receiver 220 and the content provider 205. By being a persistent back-channel, the feedback channel 240 can provide quick, real-time feedback. Such real-time feedback can allow for quick modification of the content broadcast thereby leading to a higher level of consumer satisfaction with content and potentially greater profits for the content provider by allowing the content provider to quickly tailor the broadcast to avoid wasting bandwidth on content that will not be consumed.

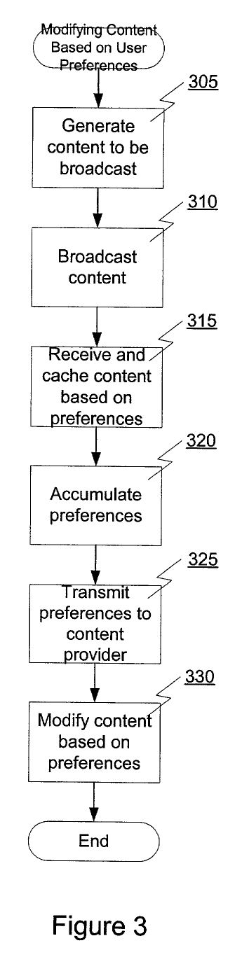

FIG. 3 is a flowchart illustrating a high-level view of modifying content based on user preferences according to one embodiment of the present invention. First, at processing block 305, a content provider generates content to be broadcast. The content is then broadcast at processing block 310. At processing block 315, a receiver receives the broadcast and selectively caches the content based upon a comparison of metadata within the content and user preferences stored on the receiver. The metadata represents channel and content descriptors made up of attribute/value pairs. Preferences are then accumulated at processing block 320 based on feedback from the user. As described above, this feedback can be active or passive or a combination of both. Information about the user preferences are transmitted to the content provider at processing block 325. This transmission can be sent over a persistent backchannel between the receiver and the content provider system. Finally, at processing block 330, the content provider uses the preference information to modify future broadcast schedules.

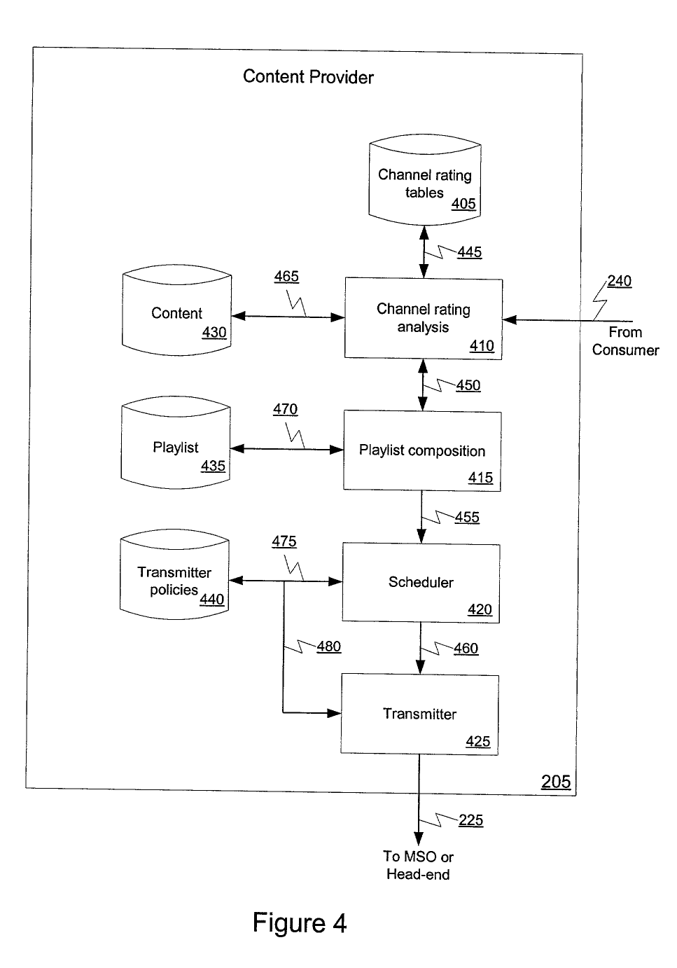

FIG. 4 is a block diagram illustrating a content provider system to generate and modify content based on user preferences according to one embodiment of the present invention.

In this example, a content provider system 205 consists of databases for storing channel rating tables 405, content to be broadcast 430, playlists 435, and transmitter policies 440. Also included are a channel rating analysis module 410, a playlist composition module 415, a scheduler 420, and a transmitter 425. In this system, a playlist is composed by the playlist composition module 415 and stored in the playlist database 435. The playlist represents a sequence or ordered list of content from the content database 430 to be broadcast.

The scheduler 420 has mechanisms to bind network resources to appropriate content pieces based on transmitter policies 440 and playlists 435. For example, the scheduler 420 may determine, based on the playlist 435, that the content provider system 205 needs to transmit data at 4Mbits/sec from 8 am to 8 pm. The scheduler 420 then determines, based on the transmitter policies 440, whether this transmission is possible.

The transmitter 425 takes content data from the content database 430 and generates a transmission bitstream. As mentioned above, instead of content being a linear set of content pieces as is common with analog broadcasts, the content is composed of a number of groupings of content. Included in this content are multiple descriptors used to designate these groupings as well as the individual content. The transmitter 425 inserts descriptors into the bitstream for transmission 225 to an MSO or head-end where it will ultimately be distributed to consumers.

Ultimately, the content provider 205 may want to utilize feedback information 240 from a set of users to influence what is being broadcast. As will be described further below, this feedback can generated at the receiver either actively or passively. Once received by the content provider 205, the feedback information is used by the channel rating analysis module 410 to develop channel rating tables 405. These tables 405 are then used during playlist composition to determine what content to broadcast and when.

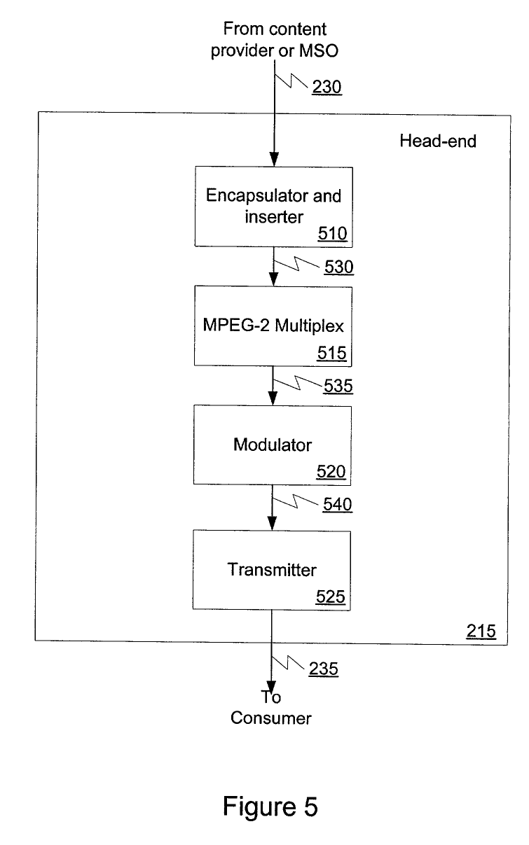

FIG. 5 is a block diagram illustrating an head-end system for distributing content according to one embodiment of the present invention. Here, the head-end 215 consists of an encapsulator and inserter 510, an MPEG-2 multiplex 515, a modulator 520, and a transmitter 525. The encapsulator and inserter 510 picks up a bitstream sent from the content provider or MSO 230 and inserts data into the MPEG-2 multiplex 515. If the entire broadcast spectrum is not owned by the content provider, the bitstream is inserted among other bitstreams from other content providers to form a multiplex. This results in a new MPEG-2 multiplex 515 which will be modulated onto a carrier frequency by the modulator 520 and transmitted to consumers 235 by the transmitter 525.

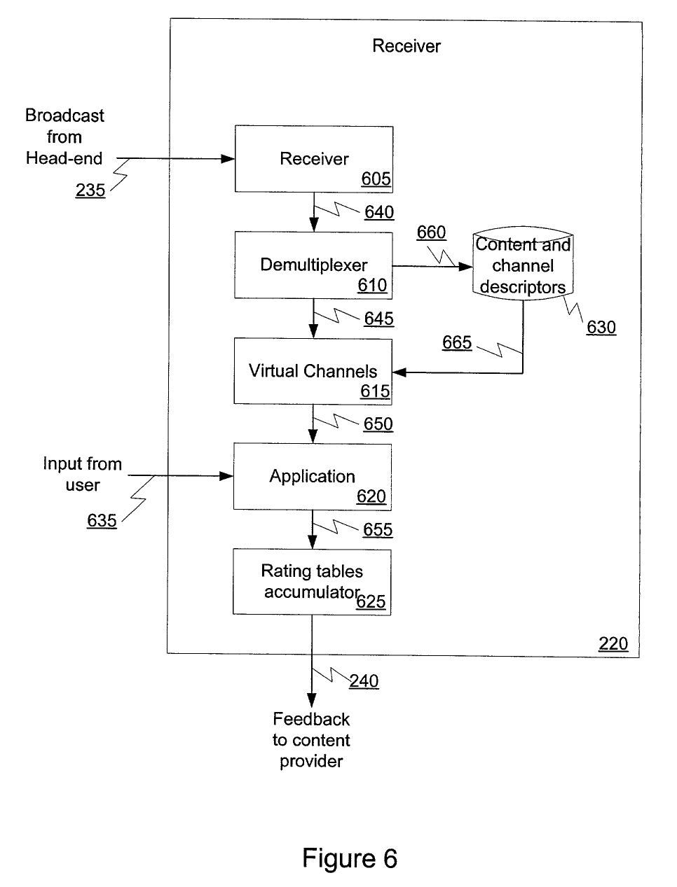

FIG. 6 is a block diagram illustrating a receiver according to one embodiment of the present invention. The receiver 220 is located with the consumer typically in his home. This device 220 could be a personal computer (PC), set top box, personal video recorder (PVR) residential gateway, media server in home, a television with a built in decoder, etc. In other words, it is a content consuming device of some type. The receiver 220 accepts input 235 from the head-end 215, decodes it and then caches or presents it to the consumer for immediate consumption.

As described above, a digital broadcast need not be like an analog broadcast in that it does not need to be consumed in real-time. These broadcast can be cached and time shifted. According to one embodiment of the present invention, the receiver 220 acts as a caching device to store content for later consumption. However, only that data which is of interest to the consumer is cached. As will be described below, the receiver can compare the metadata within the content with a locally stored user profile and determine a degree of correlation. If the correlation is high, the receiver can cache the content for later consumption.

Additionally, only that content that will be cached by consumers and presumably later consumed needs to be broadcast. Otherwise, broadcasting content that is not cached wastes bandwidth. Therefore, the receiver 220 provides, according to one embodiment of the present invention, a mechanism for rating the content received and for providing feedback to the service provider to allow the service provider to dynamically introduce or edit content for a given timeslot. This can be accomplished by both active and passive means. Active feedback can be obtained through the receiver by querying the consumer regarding his preferences. Passive feedback can be obtained by monitoring the consumer's habits with regard to the types and amounts of content consumed. This feedback is then used to develop a user profile and preference data.

The receiver 220 de-multiplexes the stream, extracts the content provider's data, and provides this data to the application. So, the receiver takes in all incoming data with metadata streams that give descriptors for content and descriptors for grouping or categorizing content into virtual channels and provides user feedback both passively and actively. The device is caching information based on user profile and preferences and making decisions on what to filter on or out based on that data.

The example illustrated in FIG. 6 includes a receiver 605, a demultiplexer 610, an application module 620, a rating tables accumulator module 625 and a content and channel descriptors database 630. The receiver 605 accepts a broadcast signal 235 from a head-end. The receiver 605 demodulates the broadcast signal to obtain the content bitstream. The demultiplexer then separates the bitstream into virtual channels 615 based on channel descriptors within the bitstream. The content and channel descriptors from the bitstream are saved in the content and channel descriptors database 630. The application 620 reads the virtual channels based on the channel descriptors, caches the content of interest to the user, provides that content to the user, and provides an interface for allowing the user to input 635 preference and rating information. According to one embodiment, the virtual channels are user specific. For example, more bandwidth can be provided in areas of interest to the active user and less bandwidth for other content.

The preference and rating information is accumulated in the rating tables accumulator 625 for later feedback to the content provider 240. This can be accomplished by both active and passive means. Active feedback can be obtained through the receiver by querying the consumer regarding his preferences. Passive feedback can be obtained by monitoring the consumer's habits with regard to the types and amounts of content consumed. This feedback is then used to develop a user profile and preference data. According to one embodiment of the present invention, profile information is kept resident on the receiver so that it can be private. Only a sanitized version of the information is sent to the content provider. For example, only a vote, such as yes or no is sent to the content provider. This provides maximum privacy but minimal details for feedback. Alternatively, predefined levels may be used to rate the content. This method provides greater detail but less privacy. Another alternative is to provide even more detailed information regarding a consumer's viewing habits such as the amount of time spend viewing particular types of content. This method would provide the most accurate and useful information to the content provider but the least privacy to the consumer.

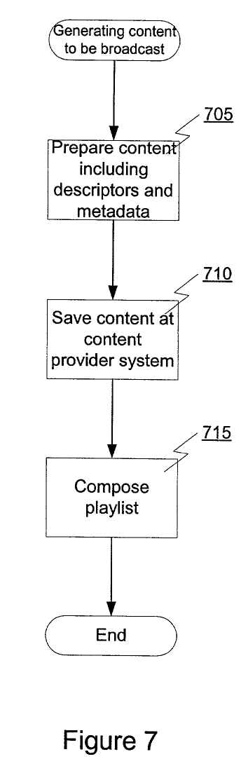

FIG. 7 is a flowchart illustrating a process for generating content to be broadcast according to one embodiment of the present invention. Initially, at processing block 705 content is prepared with descriptors and other related metadata. Metadata is also generated to be able to classify content into virtual channels. This can be based on the content type, genre, sub-genre, specific user experience for the application, etc. Next, at processing block 710 the content is cached at the content provider system for composing playlists. Finally, at processing block 715, a playlist is composed. The playlist composition is aided by a combination of editorial input, user community profile, and other information. Playlists are composed for transmission on specific networks with specific audiences in mind.

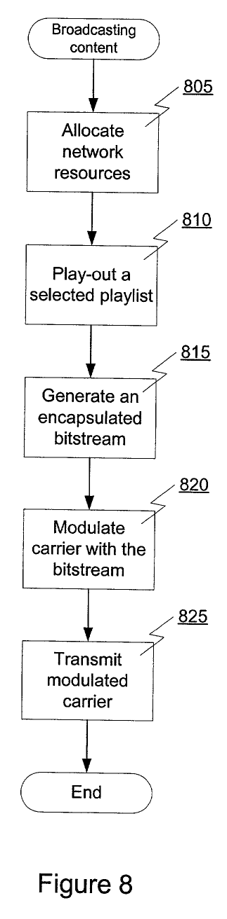

FIG. 8 is a flowchart illustrating a process for broadcasting content according to one embodiment of the present invention. First, at processing block 805, network resources are allocated. As described above, the scheduler will use the playlist and allocate the appropriate network resources to be able to transmit this content in a given timeslot. Next at processing block 810, at the required time, the transmitter will playout a given playlist and associated transmission policies. At processing block 815 an encapsulated bitstream is generated. As described above, the inserter will generate an encapsulated bitstream that is inserted into the multiplex. A carrier frequency is then modulated with the encapsulated bitstream at processing block 820. Finally, at processing block 825, the aggregate transport stream is broadcast over the broadcast spectrum.

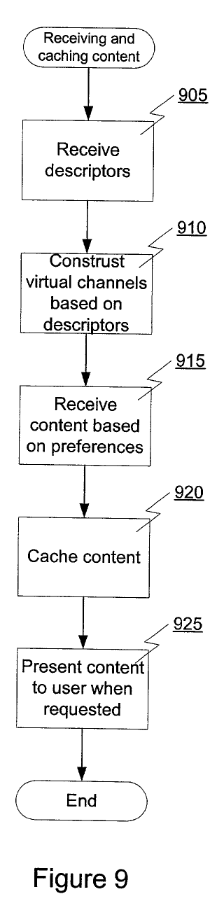

FIG. 9 is a flowchart illustrating a process for receiving and caching content according to one embodiment of the present invention. Initially, at processing block 905, the receiver tunes into the program and receives the content descriptors and virtual channel descriptors for this program/timeslot. Next, at processing block 910, the receiver will construct the virtual channels as groupings of content based on the content, channel descriptors, and potentially, user profile information. Based on the user's preferences, the receiver will receive the content from these virtual channels at processing block 915. At processing block 920 once received, the content is cached at the receiver, wherein the receiver acts as a caching device and will manage the usage and lifetime of the content based on the descriptors and other metadata that was received along with the content. When the user is ready to experience the content, the virtual channels are presented to the user at processing block 925. The user can “tune into” and experience one of these virtual channels created from the content cache at a time.

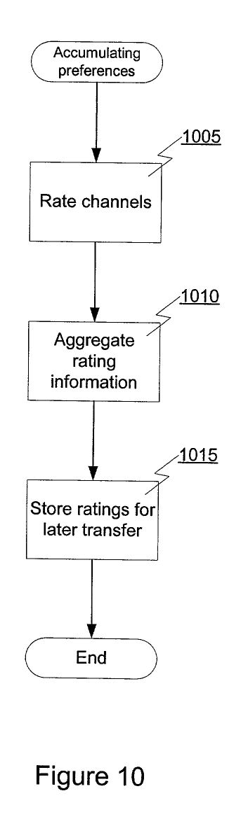

FIG. 10 is a flowchart illustrating a process for accumulating user preferences according to one embodiment of the present invention. First, at processing block 1005, the user can interactively rate these channels by giving them a rating on a well-defined scale. The rating information is aggregated at the receiver device at processing block 1010. This information is stored at the receiver at processing block 1015 for periodic feedback transmission to the operations center.

What is claimed is:

1. A method comprising:
generating content to be broadcast from a content provider system by embedding content descriptors and metadata within content data stored on the content provider system;
broadcasting said content to at least one receiver connected with said content provider system via a network;
receiving said content at the receiver;
selectively caching or presenting said content at the receiver based on a comparison of the content descriptors and metadata embedded in the content and user preference data stored on the receiver;
accumulating user preferences regarding content received;
transmitting said user preferences from the receiver; and
modifying future content to be broadcast based on said user preferences.

2. The method of claim 1, wherein said receiving said content comprises caching the content on the receiver.

3. The method of claim 2, wherein said caching is done on a hard disk drive within the receiver.

4. The method of claim 1, wherein said accumulating user preferences comprises requesting active user feedback regarding the user's opinion of the content.

5. The method of claim 1, wherein said broadcasting comprises transmitting a digital data service via an IP multicast.

6. The method of claim 1, wherein said accumulating user preferences comprises passive user participation by gathering information regarding the user's pattern of consuming content without requesting direct feedback from the user.

7. The method of claim 1, wherein said transmitting said user preferences is preformed via a persistent back-channel between the receiver and the content provider system.

8. A system comprising:
a content provider system to embed content descriptors and metadata within content data stored on the content provider system, broadcast said content over a first network connected with the content provider system, receive feedback regarding user preferences via a feedback channel connected with the content provider, and modify future content broadcasts based on said feedback;
a head-end connected with said first network to receive content from the content provider system, encapsulate said content within a multiplex, and transmit said multiplex over a second network connected with the head-end;
a receiver connected with said second network to receive the multiplex from the head-end, de-multiplex the multiplex to extract the content from the content provider system, receive content, selectively cache or present the content based on a comparison of the content descriptors and metadata embedded in the content and user preference data stored on the receiver, accumulate user preferences regarding content received, and transmit said user preferences via a feedback channel coupled with the receiver.

9. The system of claim 8, wherein said receiver caches content containing content descriptors that match said user preference data stored on the receiver.

10. The system of claim 9, wherein said receiver caches content on a hard disk drive within the receiver.

11. The system of claim 8, wherein said user preferences regarding content received are accumulated by the receiver comprise active user feedback regarding the user's opinion of content.

12. The system of claim 8, wherein said broadcast of content from the content provider system comprises an IP multicast.

13. The system of claim 8, wherein said user preferences regarding content received are accumulated by the receiver comprise active user feedback regarding the user's opinion of content.

14. The system of claim 8, wherein said multiplex comprises an MPEG2 multiplex.

15. The system of claim 8, wherein said feedback channel coupled with the receiver and the content provider comprises a persistent backchannel.

16. A content provider system comprising:
a playlist composition subsystem to embed content descriptors and metadata within content data stored on the content provider system;
a transmitter to broadcast said content over a first network connected with the content provider system; and
a channel rating analysis subsystem to receive feedback regarding user preferences via a feedback channel connected with the content provider, and modify future content broadcasts based on said feedback

17. The content provider system of claim 16, wherein said first network comprises an Asynchronous Transfer Mode (ATM) backbone.

18. The content provider system of claim 18, wherein said broadcasting comprises transmitting a digital data service via an IP multicast.

19. A receiver comprising:
a receiver connected with a network to receive broadcast multiplex from a content provider system wherein the multiplex contains content descriptors and metadata within content data;
a de-multiplexer to de-multiplex the multiplex to extract the content data from the content provider system and receive content; and
an application to selectively cache or present the content based on a comparison of the content descriptors and metadata embedded in the content and user preference data stored on the receiver, accumulate user preferences regarding content received, and transmit said user preferences via a feedback channel coupled with the receiver.

20. The receiver of claim 19, wherein said caching is done on a hard disk drive within the receiver.

21. The receiver of claim 19, wherein said accumulating user preferences comprises requesting active user feedback regarding the user's opinion of the content.

22. The receiver of claim 19, wherein said accumulating user preferences comprises passive user participation by gathering information regarding the user's pattern of consuming content without requesting direct feedback from the user.

23. The receiver of claim 19, wherein said transmitting said user preferences is preformed via a persistent back-channel between the receiver and the content provider system.

24. A machine-readable medium having stored thereon data representing sequences of instructions, the sequences of instructions which, when executed by a processor, cause the processor to:
generate content to be broadcast from a content provider system by embedding content descriptors and metadata within content data stored on the content provider system;
broadcast said content to at least one receiver connected with said content provider system via a network;
receive said content at the receiver; selectively cache or present said content on the receiver based on a comparison of the content descriptors and metadata embedded in the content and user preference data stored on the receiver;
accumulate user preferences regarding content received;
transmit said user preferences from the receiver; and
modify future content to be broadcast based on said user preferences.

25. The machine-readable medium of claim 24, wherein said receiving said content comprises caching the content on the receiver.

26. The machine-readable medium of claim 25, wherein said caching is done on a hard disk drive within the receiver.

27. The machine-readable medium of claim 24, wherein said accumulating user preferences comprises requesting active user feedback regarding the user's opinion of the content.

28. The machine-readable medium of claim 24, wherein said broadcasting comprises transmitting a digital service via an IP multicast.

29. The machine-readable medium of claim 24, wherein said accumulating user preferences comprises passive user participation by gathering information regarding the user's pattern of consuming content without requesting direct feedback from the user.

30. The machine-readable medium of claim 24, wherein said transmitting said user preferences is preformed via a persistent back-channel between the receiver and the content provider system.
